(19) United States
(12) Patent Application Publication
(10) Pub. No.: US 2025/0068881 A1
(43) Pub. Date: Feb. 27, 2025

(54) TRAINING A CONTEXT-AWARE CHATBOT

(71) Applicant: International Business Machines Corporation, Armonk, NY (US)

(72) Inventors: Logan Bailey, Atlanta, GA (US); Martin G. Keen, Cary, NC (US); Jeremy R. Fox, Georgetown, TX (US); Zachary A. Silverstein, Georgetown, TX (US)

(21) Appl. No.: 18/454,882

(22) Filed: Aug. 24, 2023

(51) Int. Cl. G06N 3/006; G06F 40/279; G06F 40/30

(52) U.S. Cl. CPC G06N 3/006; G06F 40/279; G06F 40/30

(57) ABSTRACT

A computer-implemented method, a computer program product, and a computer system for training a context-aware chatbot. A computer receives a prompt form a user, where the prompt has a level of ambiguity. A computer identifies context of the prompt, by analyzing collected data from various sources. A computer identifies an intent of the prompt, by using natural language processing to disambiguate the prompt. A computer provides a modified prompt, according to the context and the intent. A computer selects datasets relevant to the context. A computer generates a response to the prompt, based on the modified prompt and the datasets, where the context-aware chatbot responds to the prompt with the response.

### BACKGROUND

The present invention relates generally to a chatbot, and more particularly to training a context-aware chatbot.

Chatbots are increasingly becoming an important tool for providing users with quick access to information. However, the quality of chatbot responses can be poor due to a variety of reasons. The poor quality may be caused by limited and irrelevant training data. The poor quality may also caused by ambiguous and insufficient input prompts from users. The poor quality of chatbot responses can lead to a poor user experience and time spent searching for the right information.

### SUMMARY

In one aspect, a computer-implemented method for training a context-aware chatbot is provided. The computer-implemented method includes receiving a prompt form a user, where the prompt has a level of ambiguity. The computer-implemented method further includes identifying context of the prompt, by analyzing collected data from various sources. The computer-implemented method further includes identifying an intent of the prompt, by using natural language processing to disambiguate the prompt. The computer-implemented method further includes providing a modified prompt, according to the context and the intent. The computer-implemented method further includes selecting datasets relevant to the context. The computer-implemented method further includes generating a response to the prompt, based on the modified prompt and the datasets, where the context-aware chatbot responds to the prompt with the response.

In another aspect, a computer program product for training a context-aware chatbot is provided. The computer program product comprises a computer readable storage medium having program instructions embodied therewith, and the program instructions are executable by one or more processors. The program instructions are executable to: receive a prompt form a user, where the prompt has a level of ambiguity; identify context of the prompt, by analyzing collected data from various sources; identify an intent of the prompt, by using natural language processing to disambiguate the prompt; provide a modified prompt, according to the context and the intent; select datasets relevant to the context; and generate a response to the prompt, based on the modified prompt and the datasets, where the context-aware chatbot responds to the prompt with the response.

In yet another aspect, a computer system for training a context-aware chatbot is provided. The computer system comprises one or more processors, one or more computer readable tangible storage devices, and program instructions stored on at least one of the one or more computer readable tangible storage devices for execution by at least one of the one or more processors. The program instructions are executable to receive a prompt form a user, where the prompt has a level of ambiguity. The program instructions are further executable to identify context of the prompt, by analyzing collected data from various sources. The program instructions are further executable to identify an intent of the prompt, by using natural language processing to disambiguate the prompt. The program instructions are further executable to provide a modified prompt, according to the context and the intent. The program instructions are further executable to select datasets relevant to the context. The program instructions are further executable to generate a response to the prompt, based on the modified prompt and the datasets, where the context-aware chatbot responds to the prompt with the response.

### BRIEF DESCRIPTION OF THE SEVERAL VIEWS OF THE DRAWINGS

FIG. 1 illustrates four stages of training a context-aware chatbot, in accordance with one embodiment of the present invention.

FIG. 2 is a flowchart showing operational steps of training a context-aware chatbot, in accordance with one embodiment of the present invention.

FIG. 3 is a systematic diagram illustrating an example of an environment for the execution of at least some of the computer code involved in performing training a context-aware chatbot, in accordance with one embodiment of the present invention.

### DETAILED DESCRIPTION

Embodiments of the present invention disclose a computer-implemented method for training a context-aware chatbot. The computer-implemented method includes receiving a prompt form a user, where the prompt has a level of ambiguity. The computer-implemented method further includes identifying context of the prompt, by analyzing collected data from various sources. The computer-implemented method further includes identifying an intent of the prompt, by using natural language processing to disambiguate the prompt. The computer-implemented method further includes providing a modified prompt, according to the context and the intent. The computer-implemented method further includes selecting datasets relevant to the context. The computer-implemented method further includes generating a response to the prompt, based on the modified prompt and the datasets, where the context-aware chatbot responds to the prompt with the response.

In some embodiments, the computer-implemented method further includes determining the level of the ambiguity of the prompt. In some further embodiments, the computer-implemented method further includes pre-processing the collected data to provide pre-processed data with correct formats and free from irrelevant words or phrases, where the various sources of the collected data include video conferencing services, instant messages, and email messages. In some further embodiments, the computer-implemented method further includes applying one or more of tokenization, stemming, lemmatization, and stop word removal to pre-process the collected data. In some further embodiments, the computer-implemented method further includes applying one or more of autoregressive integrated moving average, part-of-speech tagging, and named entity recognition to identify the context of the prompt. In some further embodiments, the computer-implemented method further includes applying one or more of sentiment analysis, intent recognition, and entity extraction to identify the intent of the prompt. In some further embodiments the computer-implemented method further includes applying one or more of topic modelling, text categorization, and clustering to select the datasets relevant to the context.

Embodiments of the present invention disclose a computer program product for training a context-aware chatbot is provided. The computer program product comprises a computer readable storage medium having program instructions embodied therewith, and the program instructions are executable by one or more processors. The program instructions are executable to: receive a prompt form a user, where the prompt has a level of ambiguity; identify context of the prompt, by analyzing collected data from various sources; identify an intent of the prompt, by using natural language processing to disambiguate the prompt; provide a modified prompt, according to the context and the intent; select datasets relevant to the context; and generate a response to the prompt, based on the modified prompt and the datasets, where the context-aware chatbot responds to the prompt with the response.

In some embodiments of the computer program product, the program instructions are further executable to determine the level of the ambiguity of the prompt. In some further embodiments of the computer program product, the program instructions are further executable to pre-process the collected data to provide pre-processed data with correct formats and free from irrelevant words or phrases, where the various sources of the collected data include video conferencing services, instant messages, and email messages. In some further embodiments of the computer program product, the program instructions are further executable to apply one or more of tokenization, stemming, lemmatization, and stop word removal to pre-process the collected data. In some further embodiments of the computer program product, the program instructions are further executable to apply one or more of autoregressive integrated moving average, part-of-speech tagging, and named entity recognition to identify the context of the prompt. In some further embodiments of the computer program product, the program instructions are further executable to apply one or more of sentiment analysis, intent recognition, and entity extraction to identify the intent of the prompt. In some further embodiments of the computer program product, the program instructions are further executable to apply one or more of topic modelling, text categorization, and clustering to select the datasets relevant to the context.

Embodiments of the present invention disclose a computer system for training a context-aware chatbot is provided. The computer system comprises one or more processors, one or more computer readable tangible storage devices, and program instructions stored on at least one of the one or more computer readable tangible storage devices for execution by at least one of the one or more processors. The program instructions are executable to receive a prompt form a user, where the prompt has a level of ambiguity. The program instructions are further executable to identify context of the prompt, by analyzing collected data from various sources. The program instructions are further executable to identify an intent of the prompt, by using natural language processing to disambiguate the prompt. The program instructions are further executable to provide a modified prompt, according to the context and the intent. The program instructions are further executable to select datasets relevant to the context. The program instructions are further executable to generate a response to the prompt, based on the modified prompt and the datasets, where the context-aware chatbot responds to the prompt with the response.

In some embodiments of the computer system, the program instructions are further executable to determine the level of the ambiguity of the prompt. In some further embodiments of the computer system, the program instructions are further executable to pre-process the collected data to provide pre-processed data with correct formats and free from irrelevant words or phrases, where the various sources of the collected data include video conferencing services, instant messages, and email messages, and where one or more of tokenization, stemming, lemmatization, and stop word removal are applied for pre-processing the collected data. In some further embodiments of the computer system, the program instructions are further executable to apply one or more of autoregressive integrated moving average, part-of-speech tagging, and named entity recognition to identify the context of the prompt. In some further embodiments of the computer system, the program instructions are further executable to apply one or more of sentiment analysis, intent recognition, and entity extraction to identify the intent of the prompt. In some further embodiments of the computer system, the program instructions are further executable to apply one or more of topic modelling, text categorization, and clustering to select the datasets relevant to the context.

Embodiments of the present invention address issues of the poor quality of chatbot responses in current chatbots. Embodiments of the present invention create a more effective and efficient way to train chatbots and improve the quality of their responses. In embodiments of the present invention, training chatbots and improving the quality of their responses can be done by detecting context of the user's communication and using this information. Embodiments of the present invention disambiguate user's input prompts and limit the datasets used by chatbots to those that are relevant to the user's current context. Thus, embodiments of the present invention provide chatbots with context-aware prompts. As a result, the quality of the user's input prompts can be improved by providing the context-aware prompts. By using the context-aware prompts, chatbots can provide more relevant and accurate responses to user's input prompts, even if user's input prompts are not entirely clear and/or specific. Embodiments of the present invention greatly improve the effectiveness of chatbots and enhance the overall user experience.

Embodiments of the present invention disclose a system and method that take surrounding context of a user's interactions and external communications to disambiguate a path on a virtual agent. The system and method detect the context of the user's communication in order to disambiguate user requests and improve the quality of the input prompts. The system and method limit datasets used by a chatbot to those that are relevant to the user's current context. The system and method provide users with context-aware responses and prompts. The system and method improve the quality of the chatbot's responses by drawing from a specific corpus of information related to the user's current context.

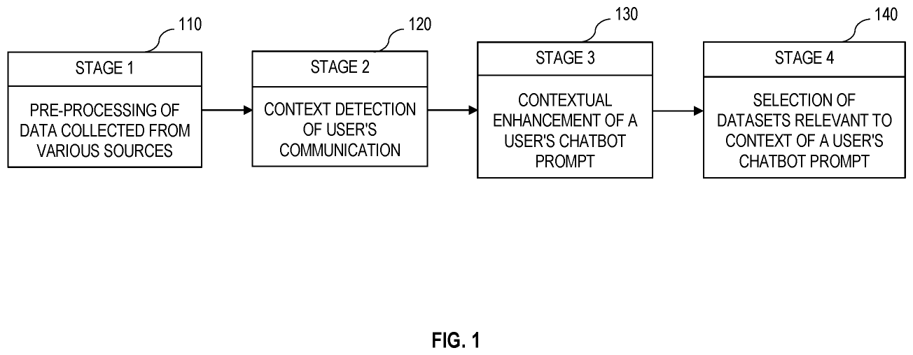

FIG. 1 illustrates four stages of training a context-aware chatbot, in accordance with one embodiment of the present invention. In the four stages of training the context-aware chatbot, stage 1 110 is a stage of pre-processing of data collected from various sources. In training the context-aware chatbot, data from various sources of a user is collected and pre-processed. The various sources include but not limited to video conferencing services, instant messages, and email messages.

The stage of pre-processing of the data collected from the various sources involves cleaning the collected data. Cleaning the collected data includes, for example, removing any irrelevant words or phrases and transforming the data into a format that can be used by three following stages (i.e., stage 2 120, stage 3 130, and stage 4 140) of training the context-aware chatbot. For example, words can be tokenized into individual units and irrelevant words or phrases can be removed. Examples of pre-processing techniques include tokenization, stemming, lemmatization, and stop word removal. The tokenization involves breaking a sentence into individual words or phrases. The stemming involves reducing a word to its base form. The lemmatization is also a process of reducing a word to its base form. The stop word removal is a process of removing words that are not relevant to the context.

In stage 1 110, the data collected from various sources is pre-processed and pre-processed data is generated. The pre-processed data is fed to the system proposed in the present invention and used by the three following stages (i.e., stage 2 120, stage 3 130, and stage 4 140). Stage 1 110 ensures that the pre-processed data is in correct formats and is free from any irrelevant words or phrases. Stage 1 110 is an important stage in improving the quality of the chatbot's responses.

In the four stages of training the context-aware chatbot, stage 2 120 is a stage of context detection of user's communication. In stage 2 120, the pre-processed data (which is obtained in stage 1 110) is analyzed to detect the context of the user's communication. In analyzing the pre-processed data, various techniques are applied. As an example, one of the techniques is autoregressive integrated moving average (ARIMA). The ARIMA technique performs time-series analysis to identify trends and patterns in the pre-processed data. For example, an autoregressive component looks at how past values affect future values, such as how a current value depends on a previous value. An integrated component looks at the difference between values in the series. A moving average component looks at an average of last few values. As another example, one of the techniques is part-of-speech tagging (POS). The POS technique involves tagging each word in a sentence with its part of speech. For example, the word “run” may be tagged as a verb. As yet another example, one of the techniques is named entity recognition (NER). The NER technique involves identifying and categorizing named entities in the text, such as people, locations, and organizations.

In stage 2 120, visual analysis may be performed. For example, if a user is viewing a presentation being shared over a web conference, the visual analysis will be performed. In performing the visual analysis, visual processing techniques may be used. One of the visual processing techniques is convolutional neural network (CNN). CNN is a deep learning algorithm that can be used to analyze images and identify features in the image. Another one of the visual processing techniques is object detection. The object detection involves identifying and categorizing objects in an image. Yet another one of the visual processing techniques is optical character recognition (OCR). OCR involves identifying characters in an image and extracting text from the image.

Stage 2 120 provides the system proposed in the present invention with the context of the user's communication and helps a chatbot to detect a topic of a conversation. Detecting context of the user's communication is important for providing the chatbot with the relevant datasets for responding to the user's request.

In the four stages of training the context-aware chatbot, stage 3 130 is a stage of contextual enhancement of a user's chatbot prompt. In response to a prompt entered by a user, the system proposed in the present invention scores the prompt to derive an ambiguity level of the prompt. For example, if a large language model and/or fundamental model cannot be sure what a user is requesting in a prompt, the system proposed in the present invention will gauge or score the level of ambiguity based on relevance hits.

In stage 3 130, the system proposed in the present invention uses natural language processing to disambiguate user's requests in input prompts and improve the quality of the input prompts. In stage 3 130, the system proposed in the present invention applies following techniques for disambiguating the user's requests. One of the techniques is sentiment analysis. The sentiment analysis technique is used to analyze a sentiment of the user's communication, such as whether the sentiment is positive, negative, or neutral. For example, if the user's input prompt includes words such as “trouble” or “difficult,” the sentiment analysis algorithm may detect a negative sentiment. Another one of the techniques is intent recognition. The intent recognition technique is used to identify user's intent, such as what the user is looking for or what the user needs help with. The intent recognition is done by analyzing the user's words, phrases, and sentences to determine their overall meaning. For example, if the user enters the phrase “What's the best way to optimize performance?” the intent recognition algorithm will detect that the user is looking for a solution to a performance issue. Yet another one of the techniques is entity extraction. The entity extraction technique is used to extract entities from the user's communication, such as people, locations, or organizations. The entity extraction is done by analyzing the user's words, phrases, and sentences to identify entities that are related to the user's request. For example, if the user enters the phrase “What's the best way to optimize performance?” the entity extraction algorithm will detect the contextual entities “CICS Transaction Server” and “IBM z/OS v 2.5” that are present in a currently running web conference.

In stage 3 130, the system proposed in the present invention identifies the user's intent and provides context-aware prompts that are more specific to the user's needs. The system proposed in the present invention helps to ensure that the chatbot can provide the user with the most accurate and relevant information. In stage 3 130, the system proposed in the present invention outputs a modified prompt, and the modified prompt is received by the chatbot. The modified prompt incorporates both the original prompt and contextually-derived additions to reduce the ambiguity of the original prompt.

In the four stages of training the context-aware chatbot, stage 4 140 is a stage of selection of datasets relevant to context of a user's chatbot prompt. In stage 4 140, the system proposed in the present invention limits datasets used by the chatbot to those that are relevant to the user's current context. The system proposed in the present invention uses various technologies to identify the most relevant datasets and limit the chatbot's responses to those that are most relevant to the user's current context. Topic modelling is one example of the techniques. The topic modelling technique is used to identify the most relevant topics in the user's communication and limit the datasets used by the chatbot to those that are related to those topics. Text categorization is another example of the techniques. The text categorization technique is used to categorize the user's communication and limit the datasets used by the chatbot to those that are related to the categories. Clustering is yet another example of the techniques. The clustering technique is used to cluster similar datasets and limit the datasets used by the chatbot to those that are most relevant to the user's current context.

In stage 4 140, through selecting datasets relevant to context of the user's chatbot prompt, the system proposed in the present invention helps to ensure that the chatbot provides the most relevant and accurate information to the user, even if user's request is not entirely clear or specific. Based on the datasets relevant to context of the user's chatbot prompt, the chatbot provides the user with a response that includes the most relevant and accurate information.

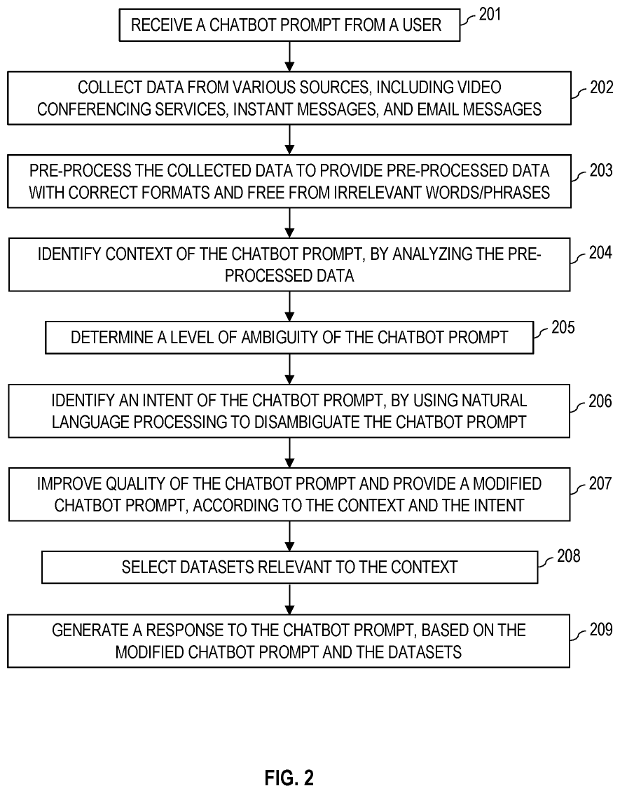

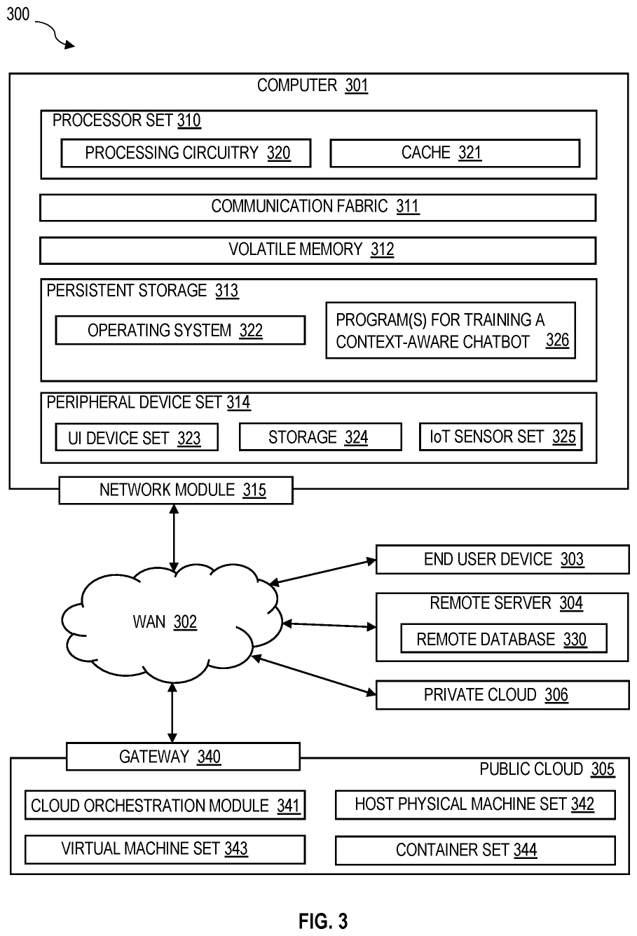

FIG. 2 is a flowchart showing operational steps of training a context-aware chatbot, in accordance with one embodiment of the present invention. The operational steps are implemented by the system proposed in the present invention. The proposed system is hosted by a computer system or server. Computer 301 shown in FIG. 3 is a typical computer system or server.

In step 201, the computer system or server receives a chatbot prompt form a user. The chatbot prompt may not be entirely clear or specific; in other words, the chatbot prompt has a level of ambiguity. Therefore, a conventional chatbot may not be able to provide a relevant and accurate response to the chatbot prompt. In following steps, the computer system or server will train a context-aware chatbot (an artificial intelligence chatbot or an AI chatbot) and therefore the context-aware chatbot is able to provide a relevant and accurate response to the chatbot prompt.

In step 202, the computer system or server collects data from various sources, including video conferencing services, instant messages, and email messages. To detect context of user's communication and topics of user's request in the chatbot prompt, the computer system or server will use the collected data from the various sources.

In step 203, the computer system or server pre-processes the collected data to provide pre-processed data with correct formats and free from irrelevant words/phrases. Pre-processing the collected data involves cleaning the collected data. Cleaning the collected data includes removing any irrelevant words or phrases and transforming the data into a format that can be used to be analyzed by the computer system or server. For example, the compute system or server applies tokenization, stemming, lemmatization, and/or stop word removal to pre-process the collected data. The computer system or server applies the tokenization technique to break a sentence into individual words or phrases. The computer system or server uses the stemming technique and/or the lemmatization technique to reduce a word to its base form. The computer system or server applies the stop word removal technique to remove words that are not relevant to the context.

In step 204, the computer system or server identifies context of the chatbot prompt, by analyzing the pre-processed data. Through the analysis of the pre-processed data, the computer system or server detects context of user's communication and topics of user's request in the chatbot prompt. Detecting the context of the chatbot prompt is important for training the context-aware chatbot to provide a relevant and accurate response to the chatbot prompt. In step 204, the computer system or server applies autoregressive integrated moving average (ARIMA) to identify trends and patterns in the pre-processed data. The computer system or server applies part-of-speech tagging (POS) to tag each word in a sentence with its part of speech. The computer system or server applies named entity recognition (NER) to identify and categorize named entities in the text, such as people, locations, and organizations.

In step 205, the computer system or server determines a level of ambiguity of the chatbot prompt. The computer system or server scores the user's chatbot prompt to derive an ambiguity level of the user's chatbot prompt. In response to determining that a large language model and/or fundamental model cannot be sure what a user is requesting in chatbot prompt, the computer system or server will determine the level of the ambiguity.

In step 206, the computer system or server identifies an intent of the chatbot prompt, by using natural language processing to disambiguate the chatbot prompt. In this step, the computer system or server determines what the user's specific need is in the user's chatbot prompt. The computer system or server applies sentiment analysis to analyze a sentiment of the user's chatbot prompt and determine whether the sentiment is positive, negative, or neutral. The computer system or server applies intent recognition to identify the user's intent; for example, the computer system or server determines what the user is looking for or what the user needs help with. The computer system or server applies entity extraction (which is done by analyzing the user's words, phrases, and sentences) to identify entities that are related to the user's request in the chatbot prompt.

In step 207, the computer system or server improves quality of the chatbot prompt and provides a modified chatbot prompt, according to the context and the intent. In this step, the computer system or server provides a context-aware prompt that is more specific to the context the user's intent. By providing the modified chatbot prompt or the context-aware prompt, the computer system or server ensures that the context-aware chatbot (an artificial intelligence chatbot or an AI chatbot) can provide the most accurate and relevant response to the chatbot prompt.

In step 208, the computer system or server selects datasets relevant to the context. In this step, the computer system or server limits datasets used by the context-aware chatbot to those that are relevant to the context of the user's chatbot prompt. In this step, the computer system or server applies a topic modelling technique to identify the most relevant topics in the user's communication and limit the datasets used by the context-aware chatbot to those that are related to those topics. In this step, the computer system or server applies a text categorization technique to categorize the user's communication and limit the datasets used by the context-aware chatbot to those that are related to the categories. In this step, the computer system or server applies clustering technique to cluster similar datasets and limit the datasets used by the context-aware chatbot to those that are most relevant to the user's current context.

In step 209, the computer system or server generates a response to the chatbot prompt, based on the modified chatbot prompt (provided in step 207) and datasets (identified in step 208). Therefore, the context-aware chatbot responds to the user's chatbot prompt with the generated response which includes the most relevant and accurate information, although the user's chatbot prompt is not entirely clear or specific.

The first use case is user-specific assistance. A user is an IT professional who frequently participates in video conferencing calls and instant messaging conversations for work. The user often needs quick access to information and is looking for a more efficient way to get the answers an IT professional needs. The user is participating in a video conferencing call about the deployment of a new software system. The user has a question about a best way to configure the new software system for optimal performance, but the user is not sure where to find the needed information. The user opens the context-aware chatbot (or AI chatbot) and submits a request for information about configuring the new software system for optimal performance. The system proposed in the present invention detects the topic of the video conferencing call and limits datasets used by the context-aware chatbot to those that are relevant to the deployment of the new software system. The context-aware chatbot provides the user with a context-aware response that is specific to the user's request and the topic of the video conferencing call.

The second use case is improving input prompts. A user submits an ambiguous prompt to the context-aware chatbot asking “What's the best way to optimize performance?” The user recently has had an email and instant messaging exchange with a colleague about the deployment of IBM CICS (Customer Information Control System) Transaction Server running on IBM z/OS v 2.5. The context-aware chatbot detects the recent email and instant messaging exchange and uses the information from the exchange to improve the quality of the input prompt. The system proposed in the present invention expands the user's prompt to “What's the best way to optimize performance for CICS Transaction Server running on IBM z/OS v 2.5?” The context-aware chatbot then provides the user with a context-aware response based on the improved or modified input prompt and relevant datasets related to the deployment of CICS Transaction Server on IBM z/OS v 2.5.

The third use case is industry-specific assistance. A healthcare organization is participating in a video conferencing call about the implementation of a new electronic medical record (EMR) system. The organization is looking for information about the best practices for using the EMR system to improve patient care. The healthcare organization opens the context-aware chatbot and submits a request for information about the best practices for using the EMR system. The system detects the topic of the video conferencing call and limits the data sets used by the chatbot to those that are relevant to the implementation of the EMR system in the healthcare industry. The chatbot provides the healthcare organization with a context-aware response that includes the most effective best practices for using the EMR system to improve patient care, based on the information from the video conferencing call and relevant data sets.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 3, computing environment 300 contains an example of an environment for the execution of at least some of the computer code involved in performing the inventive methods, such as program(s) 326 for training a context-aware chatbot. In addition to block 326, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 326, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located off chip. In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 326 in persistent storage 313.

Communication fabric 311 is the signal conduction path that allows the various components of computer 301 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface type operating systems that employ a kernel. The code included in block 326 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

What is claimed is:

1. A computer-implemented method for training a context-aware chatbot, the method comprising:
receiving a prompt form a user, wherein the prompt has a level of ambiguity;
identifying context of the prompt, by analyzing collected data from various sources;
identifying an intent of the prompt, by using natural language processing to disambiguate the prompt;
providing a modified prompt, according to the context and the intent;
selecting datasets relevant to the context; and
generating a response to the prompt, based on the modified prompt and the datasets, wherein the context-aware chatbot responds to the prompt with the response.

2. The computer-implemented method of claim 1, further comprising:
determining the level of the ambiguity of the prompt.

3. The computer-implemented method of claim 1, further comprising:
pre-processing the collected data to provide pre-processed data with correct formats and free from irrelevant words or phrases; and
wherein the various sources of the collected data include video conferencing services, instant messages, and email messages.

4. The computer-implemented method of claim 3, further comprising:
applying one or more of tokenization, stemming, lemmatization, and stop word removal to pre-process the collected data.

5. The computer-implemented method of claim 1, further comprising:
applying one or more of autoregressive integrated moving average, part-of-speech tagging, and named entity recognition to identify the context of the prompt.

6. The computer-implemented method of claim 1, further comprising:
applying one or more of sentiment analysis, intent recognition, and entity extraction to identify the intent of the prompt.

7. The computer-implemented method of claim 1, further comprising:
applying one or more of topic modelling, text categorization, and clustering to select the datasets relevant to the context.

8. A computer program product for training a context-aware chatbot, the computer program product comprising a computer readable storage medium having program instructions stored therewith, the program instructions executable by one or more processors, the program instructions executable to:
receive a prompt form a user, wherein the prompt has a level of ambiguity;
identify context of the prompt, by analyzing collected data from various sources;
identify an intent of the prompt, by using natural language processing to disambiguate the prompt;
provide a modified prompt, according to the context and the intent;
select datasets relevant to the context; and
generate a response to the prompt, based on the modified prompt and the datasets, wherein the context-aware chatbot responds to the prompt with the response.

9. The computer program product of claim 8, further comprising the program instructions executable to:
determine the level of the ambiguity of the prompt.

10. The computer program product of claim 8, further comprising the program instructions executable to:
pre-process the collected data to provide pre-processed data with correct formats and free from irrelevant words or phrases; and
wherein the various sources of the collected data include video conferencing services, instant messages, and email messages.

11. The computer program product of claim 10, further comprising the program instructions executable to:
apply one or more of tokenization, stemming, lemmatization, and stop word removal to pre-process the collected data.

12. The computer program product of claim 8, further comprising the program instructions executable to:
apply one or more of autoregressive integrated moving average, part-of-speech tagging, and named entity recognition to identify the context of the prompt.

13. The computer program product of claim 8, further comprising the program instructions executable to:
apply one or more of sentiment analysis, intent recognition, and entity extraction to identify the intent of the prompt.

14. The computer program product of claim 8, further comprising the program instructions executable to:
apply one or more of topic modelling, text categorization, and clustering to select the datasets relevant to the context.

15. A computer system for training a context-aware chatbot, the computer system comprising one or more processors, one or more computer readable tangible storage devices, and program instructions stored on at least one of the one or more computer readable tangible storage devices for execution by at least one of the one or more processors, the program instructions executable to:
receive a prompt form a user, wherein the prompt has a level of ambiguity;
identify context of the prompt, by analyzing collected data from various sources;
identify an intent of the prompt, by using natural language processing to disambiguate the prompt;
provide a modified prompt, according to the context and the intent;
select datasets relevant to the context; and
generate a response to the prompt, based on the modified prompt and the datasets, wherein the context-aware chatbot responds to the prompt with the response.

16. The computer system of claim 15, further comprising the program instructions executable to:
determine the level of the ambiguity of the prompt.

17. The computer system of claim 15, further comprising the program instructions executable to:
pre-process the collected data to provide pre-processed data with correct formats and free from irrelevant words or phrases;
wherein the various sources of the collected data include video conferencing services, instant messages, and email messages; and
wherein one or more of tokenization, stemming, lemmatization, and stop word removal are applied for pre-processing the collected data.

18. The computer system of claim 15, further comprising the program instructions executable to:
apply one or more of autoregressive integrated moving average, part-of-speech tagging, and named entity recognition to identify the context of the prompt.

19. The computer system of claim 15, further comprising the program instructions executable to:
apply one or more of sentiment analysis, intent recognition, and entity extraction to identify the intent of the prompt.

20. The computer system of claim 15, further comprising the program instructions executable to:
apply one or more of topic modelling, text categorization, and clustering to select the datasets relevant to the context.
